(19) United States
(12) Patent Application Publication
(10) Pub. No.: US 2025/0166538 A1
(43) Pub. Date: May 22, 2025

(54) DISPLAY PANEL MOTHERBOARD, METHOD FOR TESTING DISPLAY PANEL MOTHERBOARD AND DISPLAY PANEL

(71) Applicant: WUHAN CHINA STAR OPTOELECTRONICS SEMICONDUCTOR DISPLAY TECHNOLOGY CO., LTD., Wuhan (CN)

(72) Inventor: Fei LI, Wuhan (CN)

(21) Appl. No.: 17/790,380

(22) PCT Filed: May 31, 2022
(86) PCT No.: PCT/CN2022/096456

§ 371 Date: Jan. 31, 2025

(30) Foreign Application Priority Data
May 13, 2022 (CN) 202210524559.9

(51) Int. Cl. G09G 3/00

(52) U.S. Cl. CPC G09G 3/006; G09G 2330/12

(57) ABSTRACT

A display panel motherboard, a method for testing the display panel motherboard, and a display panel are provided. The display panel motherboard includes a display region and a testing region. The display region includes a plurality of display panel main bodies, and a signal input end arranged on the plurality of display panel main bodies. The testing region includes a first signal end and a control circuit, and the control circuit controls a signal channel between the first signal end and the signal input end to be on or off. The present application can narrow down a scope of defective products and enhance a testing efficiency.

### FIELD OF DISCLOSURE

The present disclosure relates to the field of display technology, and more particularly, to a display panel motherboard, a method for testing the display panel motherboard, and a display panel.

### BACKGROUND OF DISCLOSURE

With a development of display technology, display panels are more and more widely used in wearable, vehicle, mobile phone, tablet, computer, and TV products. Before a display panel is connected to a driving circuit and put into usage, its performance is required to be tested to detect defective products and prevent defective products from continuing into the subsequent process which causes material waste. Currently, a display panel motherboard is usually produced in advance, and each display panel motherboard includes a plurality of display panel main bodies distributed in an array and are tested at a same time. Since signal lines of the plurality of display panel main bodies in a same column are connected to one another, when one of the plurality of display panel main bodies has a poor display, an entire column of display panel main bodies has the poor display, and a specific location of a defective product cannot be determined. The display panel motherboard is required to be cut into separate single display panel main bodies in subsequent processes and then tested and distinguished, causing a reduction in a testing efficiency.

### Technical Issue

The present application provides a display panel motherboard, a method for testing the display panel motherboard, and a display panel which can solve a problem of a lower testing efficiency of a conventional display panel motherboard.

### Technical Solution

The present application provides a display panel motherboard including:

a display region, wherein the display region includes a plurality of display panel main bodies disposed side by side, and the plurality of display panel main bodies are each provided with a signal input end; and

a testing region formed with a testing circuit, wherein the testing circuit includes a first signal end and a control circuit, a signal channel is formed between the first signal end and the signal input end of each of the plurality of display panel main bodies, so that the first signal end controls a corresponding one of the plurality of display panel main bodies to display after receiving a first control signal; the control circuit is connected to the signal channel between the first signal end and the plurality of signal input ends, so as to control the signal channel between the first signal end and at least a portion of the plurality of signal input ends of the plurality of display panel main bodies to be on or off.

Optionally, in some embodiments of the present application, the control circuit includes a control switch connected to the signal channel and a second signal end electrically connected to the control switch, and the second signal end is configured for controlling a corresponding control switch to be on or off after receiving a second control signal.

Optionally, in some embodiments of the present application, the control circuit includes a plurality of connection lines, an end of each of the plurality of connection lines is connected to the first signal end, and another end of each of the plurality of connection lines are connected to the plurality of signal input ends of the plurality of display panel main bodies in a one-to-one correspondence to form the signal channel between the first signal end and the signal input end of each of the plurality of display panel main bodies; and at least a portion of the plurality of connection lines is connected to the control switch.

Optionally, in some embodiments of the present application, a number of a plurality of the control switches is equal to a number of the plurality of display panel main bodies and each of the plurality of connection lines is connected to one of the plurality of control switches.

Optionally, in some embodiments of the present application, the control switch includes a control end, a first connection end, and a second connection end, the second signal end is connected to the control end, and the first connection end of the control switch is connected to the first signal end, and the second connection end of the control switch is connected to the signal input end of each of the plurality of display panel main bodies in a one-to-one correspondence.

Optionally, in some embodiments of the present application, the control circuit includes a main line connected to the first signal end, and a plurality of connection nodes are provided on the main line; the control circuit further includes a plurality of branch lines an end of each of the plurality of branch lines is connected to the plurality of connection nodes in one-to-one correspondence, and another end of each of the plurality of branch lines is connected to the signal input ends of the plurality of display panel main bodies in one-to-one correspondence, so as to form the signal channel between the first signal end and the signal input end of each of the plurality of display panel main bodies; at least a portion of the main line between the two adjacent connection nodes is connected to the control switch.

Optionally, in some embodiments of the present application, a number of a plurality of the control switches is equal to a number of the plurality of display panel main bodies, and the main line between any two adjacent connection nodes is connected to the plurality of control switches, and the main line between any one of the connection nodes and the first signal end is connected to the plurality of control switches.

Optionally, in some embodiments of the present application, the control circuit includes a plurality of the second signal ends and a plurality of the control switches, and a number of the second signal ends is equal to a number of the plurality of control switches, and the plurality of second signal ends are electrically connected to the plurality of control switches in a one-to-one correspondence.

Optionally, in some embodiments of the present application, the plurality of display panel main bodies are arranged side by side in a first direction, and in the first direction, the first signal end and the plurality of second signal ends are located on a same side of the display region.

Optionally, in some embodiments of the present application, in the first direction, the plurality of second signal ends are distributed on two opposite sides of the display region.

Optionally, in some embodiments of the present application, the testing circuit further includes a third signal end, and the third signal end is electrically connected to any one of the signal input end of the plurality of display panel main bodies, so that the third signal end controls a corresponding one of the plurality of display panel main bodies to display after receiving a third control signal.

Optionally, in some embodiments of the present application, in the first direction, the first signal end and the third signal end are located on the two opposite sides of the display region; the first signal end is electrically connected to the signal input end of each adjacent display panel main bodies in the display region, and the third signal end is electrically connected to the signal input end of each of the adjacent display panel main bodies in the display region.

Optionally, in some embodiments of the present application, in the first direction, the first signal end and the third signal end are located on a same side of the display region.

Optionally, in some embodiments of the present application, the display panel motherboard includes a plurality of the display regions and a plurality of the testing regions, the plurality of display regions and the plurality of testing regions are in a one-to-one correspondence; the plurality of display regions are arranged side by side along a second direction, and an angle is between the second direction and the first direction.

Optionally, in some embodiments of the present application, the first direction is perpendicular to the second direction.

Correspondingly, the present application further provides a method for testing the display panel motherboard, and the display panel motherboard is any one of the above-mentioned display panel motherboard, the method includes:

providing the display panel motherboard;

inputting the first control signal through the first signal end of the display panel motherboard, and controlling the signal channel between the first signal end and the signal input end of each of the plurality of display panel main bodies on the display panel motherboard to be on through the control circuit on the display panel motherboard, so that the plurality of display panel main bodies display;

determining whether one of the plurality of display panel main bodies displays abnormally in the plurality of display panel main bodies;

if one of the plurality of display panel main bodies displays abnormally in the plurality of display panel main bodies, the control circuit controlling the signal channel between the first signal end and a portion of the plurality of signal input ends of the plurality of display panel main bodies to be off, so that corresponding ones of the plurality of display panel main bodies are to be off, and

determining whether one of the plurality of display panel main bodies displays abnormally in remaining ones of the plurality of display panel main bodies.

Correspondingly, the present application further provides a display panel including:

a display panel main body provided with a signal input end;

a testing portion provided with a test signal end, wherein the test portion includes a testing circuit connected between the test signal end and the signal input end; and

a circuit board disposed on the testing portion, wherein the circuit board is electrically connected to the signal input end of the display panel main body.

Optionally, in some embodiments of the present application, the testing circuit includes a signal line, an end of the signal line is connected to the test signal end, and another end of the signal line is connected to the main body of the display panel, so as to form a signal channel between the test signal end and the signal input end.

Optionally, in some embodiments of the present application, the testing circuit further includes a control switch connected to the signal line, the test portion is further provided with a signal control end, the signal control end is electrically connected to the control switch, and the signal control end is configured for controlling the control switch to be on or off after receiving a control signal.

Optionally, in some embodiments of the present application, the display panel includes a thin-film transistor layer, the thin-film transistor layer includes a first thin-film transistor, and the first thin-film transistor is located in the display panel main body; the first thin-film transistor includes a metal layer, and the signal line and the metal layer of the first thin-film transistor are disposed in a same layer.

### Beneficial Effects

In an embodiment of the present application, the display panel motherboard includes the display region and the testing region. The display region includes the plurality of display panel main bodies arranged side by side, and the plurality of display panel main bodies are each provided with the signal input end. The testing region is formed with the testing circuit, and the testing circuit includes the first signal end and the control circuit. The signal channel is formed between the first signal end and the signal input end of each plurality of display panel main bodies, so that the first signal end controls the display of the corresponding plurality of display panel main bodies after receiving the first control signal. The control circuit is connected to the signal channel between the first signal end and the plurality of signal input ends, so as to control the signal channel between the first signal end and the signal input end of at least a portion of the plurality of display panel main bodies to be on or off. In the present application, through setting the control circuit in the testing circuit on the display panel motherboard, when testing the display panel motherboard, the control circuit can be configure to control at least a portion of the signal channels to be on or off according to a display condition of the display region, thereby narrowing down a range of locations of defective products in the display region, so as to reduce an amount of subsequent checking and enhancing a testing efficiency of the display panel motherboard.

### BRIEF DESCRIPTION OF DRAWINGS

In order to describe technical solutions in the present invention clearly, drawings to be used in the description of embodiments will be described briefly below. Obviously, drawings described below are only for some embodiments of the present invention, and other drawings can be obtained by those skilled in the art based on these drawings without creative efforts.

FIG. 1 is a structural schematic view of a type of a display panel motherboard provided by an embodiment of the present application.

FIG. 2 is a structural schematic view of another type of the display panel motherboard provided by an embodiment of the present application.

FIG. 3 is a structural schematic view of another type of the display panel motherboard provided by an embodiment of the present application.

FIG. 4 is a structural schematic view of another type of the display panel motherboard provided by an embodiment of the present application.

FIG. 5 is a structural schematic view of another type of the display panel motherboard provided by an embodiment of the present application.

FIG. 6 is a structural schematic view of another type of the display panel motherboard provided by an embodiment of the present application.

FIG. 7 is a structural schematic view of another type of the display panel motherboard provided by an embodiment of the present application.

FIG. 8 is a structural schematic view of another type of the display panel motherboard provided by an embodiment of the present application.

FIG. 9 is a flowchart of a type of method for testing a display panel motherboard provided by an embodiment of the present application.

FIG. 10 is a structural schematic view of a type of a display panel provided by an embodiment of the present application.

FIG. 11 is a structural schematic view of another type of the display panel provided by an embodiment of the present application.

### DESCRIPTION OF REFERENCE NUMERALS

| Ref. No. | Element Name | Ref. No. | Element Name |
|---|---|---|---|
| 100 | display panel motherboard | 1225 | connection node |
| 110 | display region | 1226 | branch line |
| 111 | display panel main body | 123 | third signal end |
| 112 | signal input end | X | first direction |
| 120 | testing region | Y | second direction |
| 121 | first signal end | 200 | display panel |
| 122 | control circuit | 210 | testing portion |
| 1221 | second signal end | 211 | test signal end |
| 1222 | control switch | 212 | signal control end |
| 1223 | connection line | 213 | signal line |
| 1224 | main line | 220 | circuit board |

### DETAILED DESCRIPTION OF PRESENT EMBODIMENTS

The technical solution of the present application embodiment will be clarified and completely described with reference accompanying drawings in embodiments of the present application embodiment. Obviously, the present application described parts of embodiments instead of all of the embodiments. Based on the embodiments of the present application, other embodiments which can be obtained by a skilled in the art without creative efforts fall into the protected scope of the present application. In addition, it should be understood that specific implementations described here are only used to illustrate and explain the present application and are not used to limit the present application. In the present application, if no explanation is made to the contrary, orientation words such as “upper” and “lower” usually refer to upper and lower directions of a device in an actual use or a working state and specifically refer to drawing directions in drawings. Also, “inner” and “outer” refer to an outline of the device.

The present application provides a display panel motherboard, a method for testing the display panel motherboard, and a display panel, which will be described in detail below. It should be noted that a description order of the following embodiments is not intended to limit a preferred order of the embodiments.

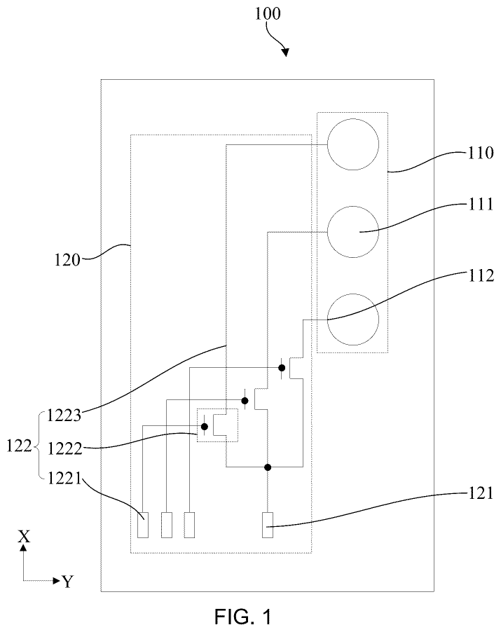

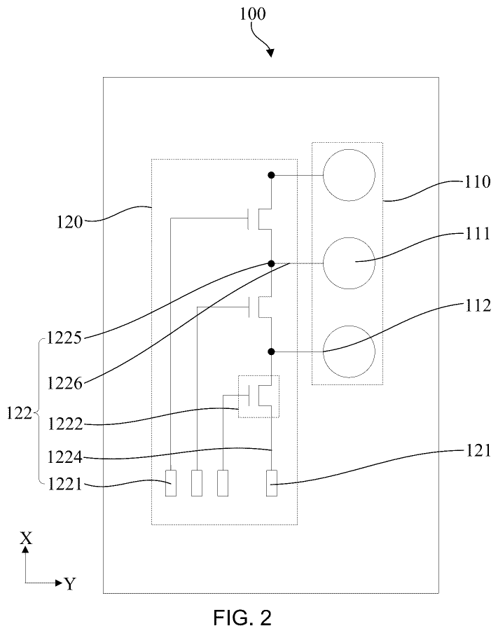

First, an embodiment of the present application provides a display panel motherboard. As shown in FIG. 1 and FIG. 2, a display panel motherboard 100 includes a display region 110. The display region 110 includes a plurality of display panel main bodies 111 arranged side by side. The plurality of display panel main bodies 111 is provided with a signal input end 112. The input control signal 112 can control a display of a corresponding one of the plurality of display panel main bodies 111.

After the display panel motherboard 100 is manufactured, the display panel motherboard 100 is required to be tested to determine whether there is a display panel main body 111 with poor display in the display region 110, so as to prevent defective products of the plurality of display panel main bodies 111 from continuing into subsequent processes or put into usage, resulting in material waste.

In addition, when manufacturing the display panel motherboard 100, in order to enhance a manufacturing efficiency, a plurality of signal lines of the plurality of display panel main bodies 111 in a same row are directly connected to one another, so that when a template of the plurality of display panel main bodies 111 is tested, the plurality of display panel main bodies 111 in the same row influence one another. That is to say, when one of the plurality of display panel main bodies 111 displays abnormally, an entire row of the plurality of display panel main bodies 111 display abnormally, which makes a location of a defective product unable to be determined. In the subsequent processes, the display panel motherboard 100 is required to be cut into individual ones of the plurality of display panel main bodies 111 and then checked one by one, causing a reduce in a testing efficiency.

In an embodiment of the present application, the display panel motherboard 100 further includes a testing region 120, and a testing circuit is formed in the testing region 120 for detecting whether or not the plurality of display panel main bodies 111 of the display region 110 can display normally. The testing circuit includes a first signal end 121, and a signal channel is formed between the first signal end 121 and the signal input end 112 of each of the plurality of display panel main bodies 111, so that the first signal end 121 controls a corresponding one of the plurality of display panel main bodies 111 to display after receiving a first control signal control signal.

That is to say, the signal channel is formed between the first signal end 121 and a plurality of signal input ends 112 of the plurality of display panel main bodies 111 at a same time. When a corresponding signal channel is to be on, through inputting he first control signal in the first signal end 121, a corresponding one of the plurality of display panel main bodies 111 can be controlled to display, and whether the corresponding one of the plurality of display panel main bodies 111 is a defective product is determined according to a display condition of the plurality of display panel main bodies 111.

The testing circuit further includes a control circuit 122, and the control circuit 122 is connected to the signal channel between the first signal end 121 and the plurality of signal input ends 112 to control the first signal end 121 and at least a portion of the plurality of signal input ends 112 of the plurality of display panel main bodies 111 to be on or off. Through a control of the control circuit 122 controlling the signal channel corresponding to a portion of the plurality of display panel main bodies 111, testing display conditions of the plurality of display panel main bodies 111 in different ranges can be achieved, so as to narrow down a range of locations of the defective products in the plurality of display panel main bodies 111, thereby enhancing the testing efficiency of the display panel motherboard 100.

In an embodiment of the present application, the control circuit 122 is arranged in the testing circuit on the display panel motherboard 100 and the control circuit 122 is connected to the signal channel between the first signal end 121 and the plurality of signal input ends 112, so that when the display panel motherboard 100 is tested, according to the display conditions of the display region 110, the control circuit 122 can control on or off of the signal channel corresponding to the portion of the plurality of display panel main bodies 111, so as to narrow down the range of the locations of the defective products in the display region 110, thereby reducing an amount of subsequent checks and enhancing the testing efficiency of the display panel motherboard 100.

Optionally, the control circuit 122 includes a control switch 1222 connected to the signal channel, and a second signal end 1221 electrically connected to the control switch 1222. The second signal end 1221 is configured for controlling a corresponding control switch 1222 to be on or off after receiving the second control signal. Through arranging the control switch 1222 on the signal channel, and utilizing the control switch 1222 being on or off to control a corresponding signal channel being on or off, so as to adjust a testing range of the display region 110.

The control switch 1222 being on or off is controlled by the second control signal received on the second signal end 1221. That is to say, the signal channel between the first signal end 121 and the signal input end 112 of each of the plurality of display panel main bodies 111 being on or off can be controlled at a same time through the first control signal received by the first signal end 121 and the second control signal received by the second signal end 1221. Through adjusting an arranging location and a connection method of the control switch 1222, separate controls of different signal channels corresponding to the plurality of panel main bodies 111 can be achieved, thereby further narrowing down the range of the locations of the defective products in the display region 110.

Optionally, as shown in FIG. 1, the control circuit 122 includes a plurality of connection lines 1223, an end of each of the plurality of connection lines 1223 is connected to the first signal end 121, and another end of each of the plurality of connection lines 1223 is connected to the plurality of display panel main bodies 111. The plurality of signal input ends 112 are connected in a one-to-one correspondence to form the signal channel between the first signal end 121 and the signal input end 112 of each of the plurality of display panel main bodies 111. That is to say, the plurality of connection lines 1223 are in a relationship of being connected parallel with one another, and the signal channel between the first signal end 121 and the signal input end 112 of each of the plurality of display panel main bodies 111 are connected in parallel with one another.

At least a portion of the plurality of connection lines 1223 are connected with the control switch 1222. Since the plurality of connection lines 1223 are connected in parallel with one another, a plurality of the control switches 1222 connected to corresponding ones of the plurality of connection lines 1223 are also connected in parallel with one another. Through adjusting the second control signal received on the second signal end 1221 connected to the corresponding control switch 1222, separate controls of the plurality of connection lines 1223 being on or off can be achieved. This circuit design method enables on or off of the signal channel between the signal input end 112 of each of the plurality of display panel main bodies 111 and the first signal end 121 corresponding to the plurality of connection lines 1223 of the control switch 1222 to be controlled separately, so that the range of the display region 110 corresponding to a test is more precise.

Optionally, a number of the plurality of control switches 1222 is equal to a number of the plurality of display panel main bodies 111, and each of the plurality of connection lines 1223 is connected to the control switch 1222. That is to say, on or off of the signal channel between the signal input end 112 of each of the plurality of display panel main bodies 111 and the first signal end 121 can be controlled by the corresponding plurality of control switches 1222 being on or off. In a testing process of the display panel motherboard 100, through controlling a single one of the plurality of control switches 1222 to be on or off, a display condition of a single one of the plurality of display panel main bodies 111 can be tested, so as to determine specific locations of the defective products in the plurality of display panel main bodies 111, and subsequent cutting and separate testing processes are not required, thereby greatly enhancing the testing efficiency of the display panel motherboard 100.

It should be noted that the control switch 1222 includes a control end, a first connection end, and a second connection end. The second signal end 1221 is connected to the control end, and the first connection end and the second connection end being on or off can be controlled through the second control signal received by the second signal end 1221. The first connection end of each of the plurality of control switches 1222 is connected to the first signal end 121, and the second connection end of each of the plurality of control switches 1222 is connected to the signal input end 112 of each of the plurality of display panel main bodies 111 in a one-to-one correspondence. That is to say, the plurality of control switches 1222 connected in parallel can be achieved, so that a plurality of signal channels between the first signal end 121 and the signal input end 112 of each plurality of display panel main bodies 111 connected in parallel can be achieved.

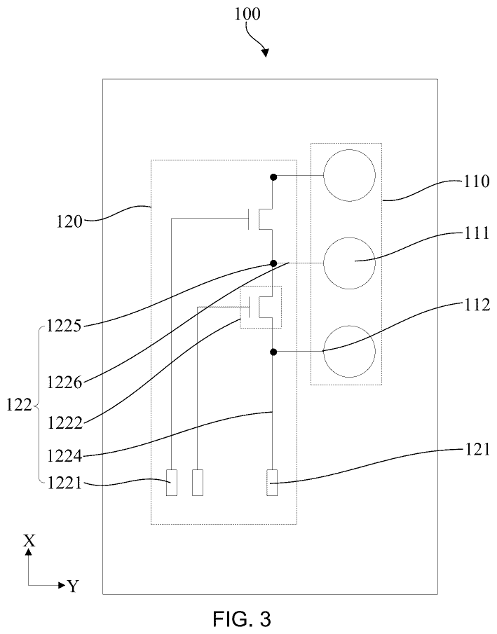

Optionally, as shown in FIG. 2 and FIG. 3, the control circuit 122 includes a main line 1224 connected to the first signal end 121, and the main line 1224 is provided with a plurality of connection nodes 1225 for other lines to be electrically connected to the first signal end 121 through corresponding ones of the plurality of connection nodes 1225. The control circuit 122 further includes a plurality of branch lines 1226, an end of the plurality of branch lines 1226 is connected to the plurality of connection nodes 1225 in a one-to-one correspondence, and another end of the plurality of branch lines 1226 are connected to the plurality of signal input ends 112 of the plurality of display panel main bodies 111 in a one-to-one correspondence, so as to form the signal channel between the first signal end 121 and the signal input end 112 of each of the plurality of display panel main bodies 111.

That is to say, the plurality of signal channels between the first signal end 121 and the plurality of signal input ends 112 of the plurality of display panel main bodies 111 corresponding to a location of the main line 1224 are partially overlapped, so that a constraint relationship is between the signal channels, i.e., when a connection node 1225 closer to the first signal end 121 and the first signal end 121 is in an off state, a connection node 1225 farther away from the first signal end 121 and the first signal end 121 is also in an off state.

The control switch 1222 is connected on the main line 1224 between at least a portion of two adjacent connection nodes 1225. Through adjusting the location of the control switch 1222 between the plurality of connection nodes 1225, separate testing of different regions of the plurality of display panel main bodies 111 can be achieved to determine the range of the locations of the defective products in the plurality of display panel main bodies 111.

Optionally, the number of the plurality of control switches 1222 is equal to the number of the plurality of display panel main bodies 111, the plurality of control switches 1222 are connected to the main line 1224 between any two adjacent connection nodes 1225, and the main line 1224 between any one of the plurality of connection nodes 1225 and the first signal end 121 is connected to the control switch 1222. That is to say, the signal channel between the signal input end 112 of each plurality of display panel main bodies 111 and the first signal end 121 is provided with the control switch 1222, and the plurality of control switches 1222 are connected in series with one another.

Through connecting the plurality of control switches 1222 in series with one another, separate testing of the different regions of the plurality of display panel main bodies 111 can be achieved to determine the range of the locations of the defective products in the plurality of display panel main bodies 111. In addition, this connection method can reduce a number of the plurality of signal lines between the plurality of signal input ends 112 of the plurality of display panel main bodies 111 and the first signal end 121 while narrowing down the range of the locations of the defective products in the plurality of display panel main bodies 111, compared to having the plurality of control switches 1222 connected parallel with one another.

It should be noted that the plurality of control switches 1222 being connected in series to one another indicates that the control end of each of the plurality of control switches 1222 is electrically connected to a corresponding one of the plurality of second signal ends 1221 respectively, and the first connection end and the second signal end between the plurality of control switches 1222 are electrically connected to one another alternately, i.e., on or off between the first connection end and the second connection end of each of the plurality of control switches 1222 is controlled by the second control signal received by the corresponding second signal end 1221, but on or off of the plurality of signal channels between the signal input end 112 of each of the plurality of display panel main bodies 111 and the first signal end 121 restrains one another, and only when the plurality of signal channels corresponding to the plurality of control switches 1222 closer to the first signal end 121 are all in an on state, the plurality of signal channels corresponding to the plurality of control switches 1222 farther away from the first signal end 121 can be in the on state.

Optionally, in an embodiment of the present application, the control circuit 122 includes the plurality of second signal ends 1221 and the plurality of control switches 1222, the number of the plurality of second signal ends 1221 is equal to the number of the plurality of control switches 1222, and the plurality of second signal ends 1221 are electrically connected to the plurality of control switches 1222 in a one-to-one correspondence, i.e., on or off of each of the plurality of control switches 1222 can be controlled separately by the second control signal received on the corresponding second signal end 1221. This design makes a control of the plurality of control switches 1222 more separable, which facilitates a mutual cooperation between different control switches 1222, and determining the range of the locations of the defective products in the plurality of display panel main bodies 111.

Specific testing methods corresponding to different arrangements and connection methods of switches will be described in detail in subsequent embodiments, and will not be reiterated herein.

Optionally, the plurality of display panel main bodies 111 are arranged side by side along a first direction X. In the first direction X, the first signal end 121 and the second signal end 1221 are located on a same side of the display region 110. The first signal end 121 and the second signal end 1221 are both configured for connecting with testing equipment, and the first signal end 121 and arranging the second signal end 1221 on the same side of the display region 110 facilitates a connection between the display panel motherboard 100 and the testing equipment.

In some embodiments, the plurality of second signal ends 1221 are distributed on two opposite sides of the display region 110. This structural design facilitates a design of connections between the plurality of second signal ends 1221 and the plurality of control switches 1222, and reduces the plurality of signal lines between the plurality of control switches 1222 and the corresponding plurality of second signal ends 1221.

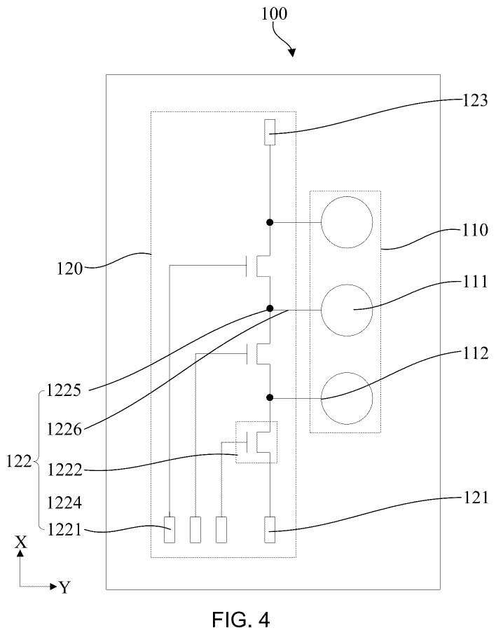

Optionally, as shown in FIG. 4 to FIG. 7, the testing circuit further includes a third signal end 123, and the third signal end 123 is electrically connected to the signal input end 112 of any one of the plurality of display panel main bodies 111, so that the third signal end 123 controls corresponding ones of the plurality of display panel main bodies 111 to display after receiving the third control signal. Through adding the third signal end 123 and directly connecting the third signal end 123 with the signal input end 112 of one of the plurality of display panel main bodies 111, the plurality of display panel main bodies 111 can be directly tested, thereby dividing the plurality of display panel main bodies 111 into two portions, and by inputting the first control signal and the third control signal to the first signal end 121 and the third signal end 123 simultaneously or separately, the range of the locations of the defective products in the plurality of display panel main bodies 111 can be further narrowed.

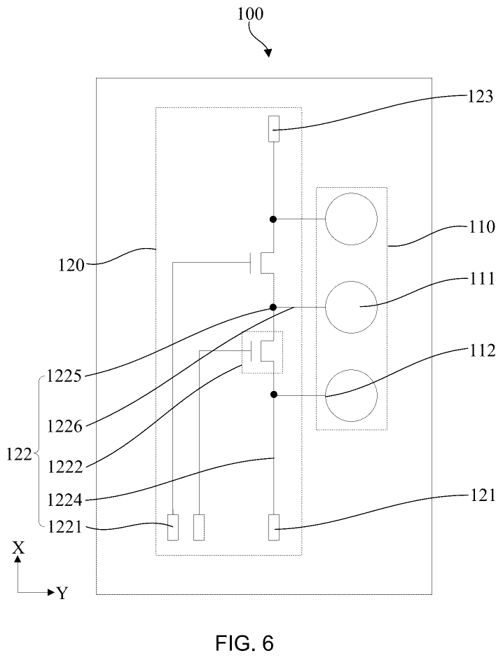

In some embodiments, as shown in FIG. 4 and FIG. 6, in the first direction X, the first signal end 121 and the third signal end 123 are located on the two opposite sides of the display region 110, and the first signal end 121 is electrically connected to signal input ends 112 of the adjacent ones of the plurality of display panel main bodies 111 in the display region 110, i.e., the first signal end 121 and the third signal end 123 are directly electrically connected to the corresponding signal input ends 112 of the adjacent plurality of display panel main bodies 111.

This connection method enables the plurality of display panel main bodies 111 located on the two opposite sides of the display region 110 in the first direction X to be directly tested, and then other regions are tested according to test results to determine the range of the locations of the defective products. In addition, this connection method can also simplify the plurality of signal lines between the third signal end 123 and the corresponding plurality of display panel main bodies 111, thereby reducing the difficulty of manufacturing.

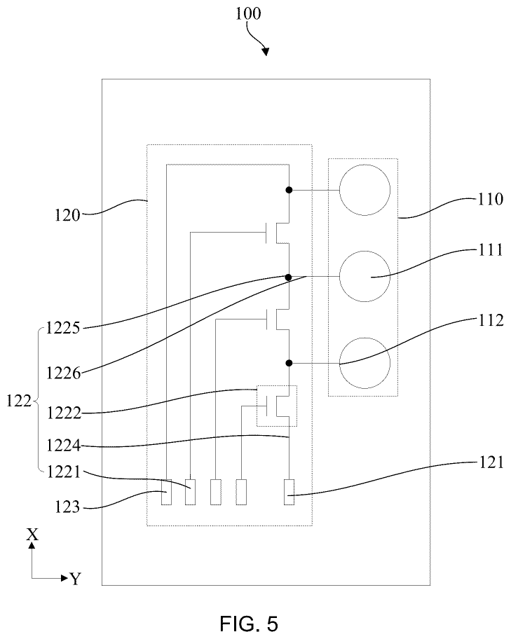

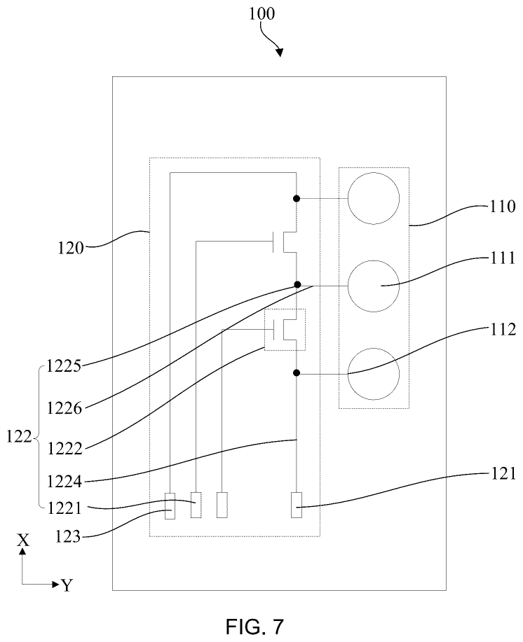

In some other embodiments, as shown in FIG. 5 and FIG. 7, in the first direction X, the first signal end 121 and the third signal end 123 are located on the same side of the display region 110. This structural design makes connection ends on the display panel mother the board 100 for connecting with the testing equipment located in the a same region of the display panel motherboard 100, thereby facilitating the connection between the display panel motherboard 100 and the testing equipment.

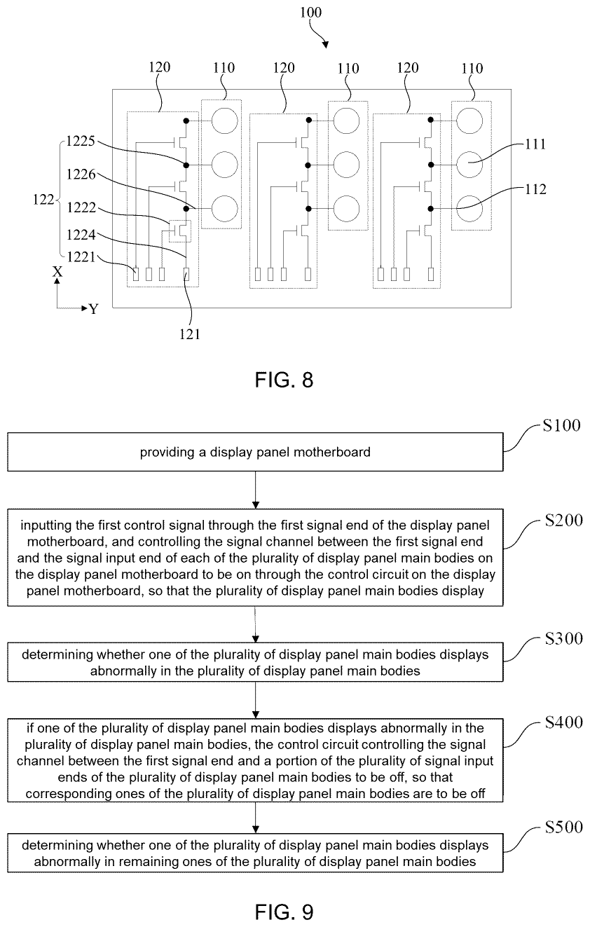

Optionally, as shown in FIG. 8, the display panel motherboard 100 includes a plurality of display regions 110 and a plurality of testing regions 120, and the plurality of display regions 110 and the plurality of testing regions 120 are arranged in a one-to-one correspondence, i.e., each of the plurality of testing regions 120 are configured for testing corresponding ones of the plurality of display regions 110 to determine the range of the locations of the defective products in each of the plurality of display regions 110 on the display panel motherboard 100.

The plurality of display regions 110 are arranged side by side along a second direction Y, and an angle is between the second direction Y and the first direction X. In some embodiments, the first direction X is perpendicular to the second direction Y, i.e., the plurality of display panel main bodies 111 on the display panel motherboard 100 are distributed in an array, and the testing region 120 is located between two adjacent display regions 110. This distribution method enables the display panel motherboard 100 to be arranged regularly overall, and can also increase a utilization rate of the display panel motherboard 100.

Secondly, an embodiment of the present application further provides a method for testing a display panel motherboard, wherein the display panel motherboard to be tested is the display panel motherboard in the above-mentioned embodiments, which includes all technical features in the above-mentioned embodiments and therefore has all beneficial effects in the above embodiments, and will not be reiterated herein.

As shown in FIG. 9, the method for testing the display panel motherboard mainly includes the following steps:

S100: providing a display panel motherboard 100.

The display panel motherboard 100 includes a display region 110 and a testing region 120, the display region 110 includes a plurality of display panel main bodies 111 arranged side by side, and the plurality of display panel main bodies 111 are each provided with a signal input end 112. The testing region 120 is formed with a testing circuit, and the testing circuit includes a first signal end 121 and a control circuit 122. A signal channel is formed between the first signal end 121 and the signal input end 112 of each of the plurality of display panel main bodies 111, so that the first signal end 121 controls corresponding ones of the plurality of display panel main bodies 111 to display after receiving the first control signal. The control circuit 122 is connected to the signal channel between the first signal end 121 and the plurality of signal input ends 112 to control the signal channel between the first signal end 121 and at least a portion of the plurality of signal input ends 112 of the plurality of display panel main bodies 111 to be on or off.

S200: inputting the first control signal through the first signal end 121 of the display panel motherboard 100, and controlling the signal channel between the first signal end 121 and the signal input end 112 of each of the plurality of display panel main bodies 111 on the display panel motherboard 100 to be on through the control circuit 122 on the display panel motherboard 100, so that the plurality of display panel main bodies 111 display.

The first signal end 121 is configured for inputting the first control signal, and the control circuit 122 is configured for controlling the signal channel between the first signal end 121 and the signal input end 112 of each of the plurality of display panel main bodies 111 to be on or off. When testing the display panel motherboard 100, through inputting the first control signal to the first signal end 121 and controlling each signal channel to be on by the control circuit 122, the first control signal received by the first signal end 121 is sent to each of the plurality of display panel main bodies 111 through the first signal end 121, so that the plurality of display panel main bodies 111 display when driven by the control signal that is received.

It should be noted that, in addition to the control signal received on the signal input end 112, other control signals are also input to the plurality of display panel main bodies 111 to ensure that the plurality of display panel main bodies 111 can display normally. The signal input end 112 can be connected to a scan signal line or a data signal line in the plurality of display panel main bodies 111. When the signal input end 112 is connected to the scan signal line of the plurality of display panel main bodies 111, the data signal line of the plurality of display panel main bodies 111 is simultaneously input with another control signal. When the signal input end 112 is connected to the data signal line of the plurality of display panel main bodies 111, the scan signal line of the plurality of display panel main bodies 111 is also input with another control signal, so that the plurality of display panel main bodies 111 display when driven cooperatively by the control signal on the data signal line and the scan signal line.

S300: determining whether one of the plurality of display panel main bodies 111 displays abnormally in the plurality of display panel main bodies 111.

After all of the plurality of signal channels between the first signal end 121 on the display panel motherboard 100 and the plurality of signal input ends 112 of the plurality of display panel main bodies 111 are to be on, whether one of the plurality of display panel main bodies 111 displays abnormally in the plurality of display panel main bodies 111 is determined according to a display condition of the display region 110 of the display panel motherboard 100 to determine whether there are defective products in the plurality of display panel main bodies 111.

It should be noted that, when some regions of the display region 110 are not bright, or bright lines or random display appear in some regions, it is determined that one of the plurality of display panel main bodies 111 display abnormally in the plurality of display panel main bodies 111. When determining, the plurality of display panel main bodies 111 in the display region 110 determined as a whole, and if an abnormality occurs, the testing and checking of a range of locations of the defective product is continued.

S400: if one of the plurality of display panel main bodies 111 displays abnormally in the plurality of display panel main bodies 111, the control circuit 122 controlling the signal channel between the first signal end 121 and a portion of the plurality of signal input ends 112 of the plurality of display panel main bodies 111 to be off, so that corresponding ones of the plurality of display panel main bodies 111 are to be off.

When the signal channels between the first signal end 121 and the signal input end 112 of each of the plurality of display panel main bodies 111 are all on, and one of the plurality of display panel main bodies 111 displays abnormally in the plurality of display panel main bodies 111, it indicates that there are the defective products in the plurality of display panel main bodies 111. The control circuit 122 controls the signal channel between the first signal end 121 and the signal input end 112 of a portion of the plurality of display panel main bodies 111 to be off, so that the corresponding portion of the plurality of display panel main bodies 111 is to be off, so that other portions of the plurality of display panel main bodies 111 can be tested and also indirectly determine whether there are the defective products in the plurality of display panel main bodies 111 that are to be off.

S500: determining whether one of the plurality of display panel main bodies 111 displays abnormally in remaining ones of the plurality of display panel main bodies 111.

After having the portion of the plurality of display panel main bodies 111 to be off, the signal channel between the signal input end 112 and the first signal end 121 of the remaining plurality of display panel main bodies 111 is remain on to determine whether one of the plurality of display panel main bodies 111 in the remaining plurality of display panel main bodies 111 displays abnormally. If the remaining plurality of display panel main bodies 111 display without abnormality, it indicates that no defective products is in the remaining plurality of display panel main bodies 111, and the defective products are in the plurality of display panel main bodies 111 that are to be off; if one of the plurality of display panel main bodies 111 displays abnormally in the remaining plurality of display panel main bodies 111, it indicates that there are defective products in the remaining plurality of display panel main bodies 111, and it is necessary to continue to have a portion of the plurality of display panel main bodies 111 to be off or adjust the range of the plurality of display panel main bodies 111 that are to be off, so as to continue narrowing down the range of the locations of the defective products in the plurality of display panel main bodies 111.

It should be noted that, as control circuits 122 differ, specific testing methods also differ, and testing methods will be described below with reference to several specific connection methods.

In some embodiments, as shown in FIG. 1, taking three display panel main bodies 111 as an example, the three display panel main bodies 111 are respectively connected to three control switches 1222 in a one-to-one correspondence, the three control switches 1222 are connected in parallel and electrically connected to the first signal end 121, and each control switch 1222 is connected to a second signal end 1221 respectively, so as to achieve a separate control of each control switch 1222 to be on or off. In a direction pointed by the first direction X arrow, a first display panel main body 111, a second display panel main body 111, and a third display panel main body 111 are sequentially disposed, and correspondingly connect to a first control switch 1222, a second control switch 1222, and a third control switch 1222, respectively.

When testing the display panel motherboard 100, firstly, the first control signal is input to the first signal end 121, and the second control signal is input to the second signal end 1221, so that all three of the control switches 1222 are to be on; and then determine whether the three display panel main bodies 111 display abnormally. When an overall display of the three display panel main bodies 111 is normal, it indicates that the three display panel main bodies 111 are all normal.

When the overall display of the three display panel main bodies 111 is abnormal, the first and the second display panel main bodies 111 are to be off, the third display panel main body 111 is to be on, and the third display panel main body 111 is determined to be normal or abnormal according to a display condition of the third display panel main body 111; then, the first and the third display panel main bodies 111 are to be off, the second display panel main body 111 is to be on, and the second display panel main body 111 is determined to be normal or abnormal according to a display condition of the second display panel main body 111; and then, the second and the third display panel main bodies 111 are to be off, the first display panel main body 111 is to be on, and the first display panel main body 111 is determined to be normal or abnormal according to a display condition of the first display panel main body 111, so as to determine which of the three display panel main bodies 111 is a normal product or a defective product.

In other embodiments, as shown in FIG. 2, the three display panel main bodies 111 are respectively connected to the three control switches 1222 in a one-to-one correspondence, the three control switches 1222 are connected in series and are electrically connected to the first signal end 121, and each of the control switches 1222 is connected to a second signal end 1221 respectively, so as to achieve the separate control of each control switch 1222 to be on or ff. In a direction pointed by the first direction X arrow, a first display panel main body 111, a second display panel main body 111, and a third display panel main body 111 are sequentially disposed, and correspondingly connect to a first control switch 1222, a second control switch 1222, and a third control switch 1222, respectively.

When testing the display panel motherboard 100, firstly, the first control signal is input to the first signal end 121, and the second control signal is input to the second signal end 1221, so that all three of the control switches 1222 are to be on; and then determine whether the three display panel main bodies 111 display abnormally. When an overall display of the three display panel main bodies 111 is normal, it indicates that the three display panel main bodies 111 are all normal.

When the overall display of the three display panel main bodies 111 is abnormal, the third control switch 1222 is to be off, and the first and the second control switches 1222 are to be on; if a display is normal, the first and the second display panel main bodies 111 are normal, and the third display panel main body 111 is abnormal; if the display is abnormal, the third and the second control switches 1222 are to be off and the first control switch 1222 is to be on; if the display is normal, the first display panel main body 111 is normal, and the second plurality of display panel main bodies 111 are abnormal; if the display is abnormal, it indicates that the first display panel main body 111 is abnormal, and the second and the third display panel main bodies 111 cannot be determined, subsequent separate checking is required for determining abnormality.

It should be noted that, as shown in FIG. 3, the first display panel main body 111 can also be directly connected to the first signal end 121, i.e., the first control switch 1222 is not provided, and only the second and the third control switches 1222 are provided. When the first control signal is input to the first signal end 121 and the second and the third control switches 1222 are to be off, the first display panel main body 111 can be determined to be normal or abnormal according to the display condition of the first display panel main body 111. In addition, only when the display of the first display panel main body 111 is normal, the second and the third display panel main bodies 111 can be determined subsequently.

In still some other embodiments, as shown in FIG. 4 and FIG. 5, a third signal end 123 is added on a basis of the embodiment shown in FIG. 2, and the third signal end 123 and the signal input end 112 of the third display panel main body 111 are directly connected. When testing the display panel motherboard 100, the first control signal is input to the first signal end 121, the third control signal is input to the third signal end 123, the third control switch 1222 is to be off, and the first signal end 122 is to be off. When the second control switch 1222 is to be on, the third display panel main body 111 being normal or abnormal can be directly determined.

If the overall display of the first and the second display panel main bodies 111 is normal, it indicates that both are normal; if the overall display of the first and the second display panel main bodies 111 is abnormal, the third and the second control switches 1222 are to be off, and the first control switch 1222 is to be off; if the display is normal, it means that the first plurality of display panel main bodies 111 is normal, and the second plurality of display panel main bodies 111 is abnormal; if the display is abnormal, it indicates that the first display panel main body 111 is abnormal, and the second display panel main body 111 cannot be determined, and subsequent separate checking is required for determining the abnormality.

It should be noted that, as shown in FIG. 6 and FIG. 7, the first display panel main body 111 can also be directly connected to the first signal end 121, i.e., the first control switch 1222 is not provided, and only the second and the third control switches 1222 are provided. When the first control signal is input to the first signal end 121, the third control signal is input to the third signal end 123, and the second and the third control switches 1222 are to be off, display conditions of the first and the third display panel main bodies 111 directly determine whether the first and the third display panel main bodies 111 are normal or abnormal. When at least one of them displays normally, the second display panel main body 111 is determined subsequently according to whether the second and the third control switches 1222 are to be on or off.

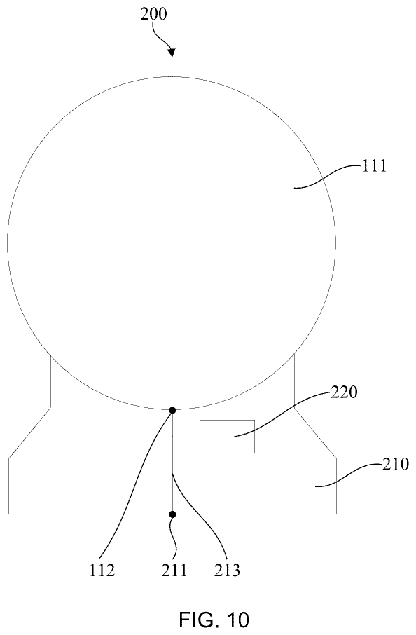

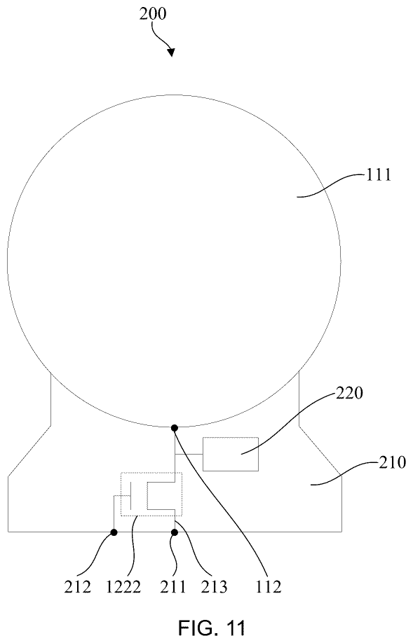

Lastly, an embodiment of the present application further provides a display panel. As shown in FIG. 10 and FIG. 11, the display panel 200 includes a plurality of display panel main bodies 111. The plurality of display panel main bodies 111 are each provided with a signal input end 112 for receiving and transmitting a control signal to the plurality of display panel main bodies 111, the plurality of display panel main bodies 111 serve as a main display portion of the display panel 200, and different display requirements of the display panel 200 can be achieved by adjusting display methods of the plurality of display panel main bodies 111.

The display panel 200 includes a testing portion 210, a test signal end 211 is disposed on the testing portion 210, and the testing portion 210 includes a testing circuit connected between the test signal end 211 and the signal input end 112. The test signal end 211 is configured for receiving a test signal, and the test signal is transmitted to the signal input end 112 through the testing circuit, and then transmitted inside the plurality of display panel main bodies 111 to control the plurality of display panel main bodies 111 to display. Through display conditions of the plurality of display panel main bodies 111, the plurality of display panel main bodies 111 can be determined to be a qualified product or a defective product, so as to prevent defective products from continuing into subsequent processes or put into usage, resulting in material waste.

The display panel 200 includes a circuit board 220, the circuit board 220 is disposed on the testing portion 210, and the circuit board 220 is electrically connected to the signal input end 112 of each of the plurality of display panel main bodies 111 to control the plurality of display panel main bodies 111 to display. Different display requirements of the display panel 200 can be achieved by adjusting a circuit control method on the circuit board 220.

It should be noted that, in a manufacturing process of the display panel 200, the plurality of display panel main bodies 111 can be tested through the testing circuit on the testing portion 210, and after the plurality of display panel main bodies 111 are determined to be qualified products, the circuit board 220 can then be connected to the testing portion 210 to prevent the material waste caused by the plurality of display panel main bodies 111 being the defective products.

The plurality of display panel main bodies 111 and the testing portion 210 in an embodiment of the present application can be formed by cutting the display panel motherboard 100 in the above-mentioned embodiment. If the plurality of display panel main bodies 111 are determined to be the qualified products when the display panel motherboard 100 is tested, the plurality of display panel main bodies 111 can directly enter a subsequent process; if the display panel motherboard 100 is tested, and the plurality of display panel main bodies 111 are determined to be the defective products or the display conditions of the plurality of display panel main bodies 111 cannot be determined, the plurality of display panel main bodies 111 can undergo a supplement testing with the testing circuit on the testing portion 210 after cutting, so as to prevent the defective products from flowing into the subsequent processes or put into usage, resulting in the material waste.

In some embodiments, when manufacturing the display panel 200, the plurality of display panel main bodies 111 and the testing portion 210 can be directly formed in advance, and then the plurality of display panel main bodies 111 can be tested through the testing circuit on the testing portion 210. If tested to be the qualified products, the plurality of display panel main bodies 111 are continued into the subsequent processes, and the circuit board 220 is connected to the testing portion 210 and the signal input end 112 of the plurality of display panel main bodies 111 to form the display panel 200.

Optionally, as shown in FIG. 10, the testing circuit includes a signal line 213, an end of the signal line 213 is connected to the test signal end 211, and another end of the signal line 213 is connected to the signal input end 112 of each of the plurality of display panel main bodies 111 to form the signal channel between the signal end 211 and the signal input end 112. That is, the test signal end 211 and the signal input end 112 are directly connected through the signal line 213. In this way, the plurality of display panel main bodies is enabled to be determined as the qualified product or the defective product according to the display conditions of the plurality of display panel main bodies 111 only through inputting the control signal to the test signal end 211, and a testing method is simple and convenient.

In some embodiments, as shown in FIG. 11, the testing circuit further includes a control switch 1222 connected to the signal line 213, the testing portion 210 is provided with a signal control end 212, and the signal control end 212 is electrically connected to the control switch 1222, and the signal control end 212 is configured for controlling the control switch 1222 to be on or off after receiving the control signal. That is to say, when testing the plurality of display panel main bodies 111, the control signal is required to be input to the signal control end 212 and the test signal end 211 at a same time, so that the control switch 1222 is to be on, and the control signal can be successfully transmitted to the plurality of display panel main bodies 111, so as to achieve determining of the display condition of the plurality of display panel main bodies 111.

In this way, after the plurality of display panel main bodies 111 continue to the subsequent processes and form the display panel 200, the control switch 1222 can be off by inputting a signal to the signal control end 212, so that the signal line 213 is in an off state. If the plurality of display panel main bodies 111 are controlled to display through the circuit board 220, the control signal on the circuit board 220 can be prevent from simultaneously transmitted on the signal lines 213, thereby affecting a display effect of the display panel 200.

It should be noted that the display panel 200 includes a thin-film transistor layer, the thin-film transistor layer includes a first thin-film transistor, the first thin-film transistor is located in a display panel main body 111, and the first thin-film transistor includes a metal layer. When the testing circuit of the testing portion 210 only includes the signal line 213, the signal line 213 and the metal layer of the first thin-film transistor can be disposed in a same layer, so as to simplify the manufacturing process of the display panel 200.

When the testing circuit further includes the control switch 1222, the control switch 1222 includes a second thin-film transistor, and the second thin-film transistor and each film layer in the first thin-film transistor are disposed in a same layer. That is to say, in the manufacturing process of the display panel 200, the first thin-film transistor in the display panel main body 111 and the second thin-film transistor in the testing portion 210 are formed at a same time, so as to further simplify the manufacturing process of the display panel 200 and reduce a production cost.

The display panel motherboard, the method for testing the display panel motherboard, and the display panel provided by the present application are described in detail above, the specific examples of this document are used to explain principles and embodiments of the present application, and the description of embodiments above is only for helping to understand the present application. Meanwhile, those skilled in the art will be able to change the specific embodiments and the scope of the present application according to the idea of the present application. In the above, the content of the specification should not be construed as limiting the present application. Above all, the content of the specification should not be the limitation of the present application.

What is claimed is:

1. A display panel motherboard comprising:
a display region, wherein the display region comprises a plurality of display panel main bodies disposed side by side, and the plurality of display panel main bodies are each provided with a signal input end; and
a testing region formed with a testing circuit, wherein the testing circuit comprises a first signal end and a control circuit, a signal channel is formed between the first signal end and the signal input end of each of the plurality of display panel main bodies, so that the first signal end controls a corresponding one of the plurality of display panel main bodies to display after receiving a first control signal; the control circuit is connected to the signal channel between the first signal end and the plurality of signal input ends, so as to control the signal channel between the first signal end and at least a portion of the plurality of signal input ends of the plurality of display panel main bodies to be on or off.

2. The display panel motherboard according to claim 1, wherein the control circuit comprises a control switch connected to the signal channel and a second signal end electrically connected to the control switch, and the second signal end is configured for controlling a corresponding control switch to be on or off after receiving a second control signal.

3. The display panel motherboard according to claim 2, wherein the control circuit comprises a plurality of connection lines, an end of each of the plurality of connection lines is connected to the first signal end, and another end of each of the plurality of connection lines are connected to the plurality of signal input ends of the plurality of display panel main bodies in a one-to-one correspondence to form the signal channel between the first signal end and the signal input end of each of the plurality of display panel main bodies; and at least a portion of the plurality of connection lines is connected to the control switch.

4. The display panel motherboard according to claim 3, wherein a number of a plurality of the control switches is equal to a number of the plurality of display panel main bodies and each of the plurality of connection lines is connected to one of the plurality of control switches.

5. The display panel motherboard according to claim 4, wherein the control switch comprises a control end, a first connection end, and a second connection end, the second signal end is connected to the control end, and the first connection end of the control switch is connected to the first signal end, and the second connection end of the control switch is connected to the signal input end of each of the plurality of display panel main bodies in a one-to-one correspondence.

6. The display panel motherboard according to claim 2, wherein the control circuit comprises a main line connected to the first signal end, and a plurality of connection nodes are provided on the main line; the control circuit further comprises a plurality of branch lines, an end of each of the plurality of branch lines is connected to the plurality of connection nodes in one-to-one correspondence, and another end of each of the plurality of branch lines is connected to the signal input ends of the plurality of display panel main bodies in one-to-one correspondence, so as to form the signal channel between the first signal end and the signal input end of each of the plurality of display panel main bodies; at least a portion of the main line between the two adjacent connection nodes is connected to the control switch.

7. The display panel motherboard according to claim 6, wherein a number of a plurality of the control switches is equal to a number of the plurality of display panel main bodies, and the main line between any two adjacent connection nodes is connected to the plurality of control switches, and the main line between any one of the connection nodes and the first signal end is connected to the plurality of control switches.

8. The display panel motherboard according to claim 2, wherein the control circuit comprises a plurality of the second signal ends and a plurality of the control switches, and a number of the second signal ends is equal to a number of the plurality of control switches, and the plurality of second signal ends are electrically connected to the plurality of control switches in a one-to-one correspondence.

9. The display panel motherboard according to claim 8, wherein the plurality of display panel main bodies are arranged side by side in a first direction, and in the first direction, the first signal end and the plurality of second signal ends are located on a same side of the display region.

10. The display panel motherboard according to claim 8, wherein, in the first direction, the plurality of second signal ends are distributed on two opposite sides of the display region.

11. The display panel motherboard according to claim 9, wherein the testing circuit further comprises a third signal end, and the third signal end is electrically connected to any one of the signal input end of the plurality of display panel main bodies, so that the third signal end controls a corresponding one of the plurality of display panel main bodies to display after receiving a third control signal.

12. The display panel motherboard according to claim 11, wherein, in the first direction, the first signal end and the third signal end are located on the two opposite sides of the display region; the first signal end is electrically connected to the signal input end of each adjacent display panel main bodies in the display region, and the third signal end is electrically connected to the signal input end of each of the adjacent display panel main bodies in the display region.

13. The display panel motherboard according to claim 11, wherein, in the first direction, the first signal end and the third signal end are located on a same side of the display region.

14. The display panel motherboard according to claim 9, wherein the display panel motherboard comprises a plurality of the display regions and a plurality of the testing regions, the plurality of display regions and the plurality of testing regions are in a one-to-one correspondence; the plurality of display regions are arranged side by side along a second direction, and an angle is between the second direction and the first direction.

15. The display panel motherboard according to claim 14, wherein the first direction is perpendicular to the second direction.

16. A method for testing the display panel motherboard as claimed in claim 1, the method comprising:
providing the display panel motherboard;
inputting the first control signal through the first signal end of the display panel motherboard, and controlling the signal channel between the first signal end and the signal input end of each of the plurality of display panel main bodies on the display panel motherboard to be on through the control circuit on the display panel motherboard, so that the plurality of display panel main bodies display;
determining whether one of the plurality of display panel main bodies displays abnormally in the plurality of display panel main bodies;
if one of the plurality of display panel main bodies displays abnormally in the plurality of display panel main bodies, the control circuit controlling the signal channel between the first signal end and a portion of the plurality of signal input ends of the plurality of display panel main bodies to be off, so that corresponding ones of the plurality of display panel main bodies are to be off; and
determining whether one of the plurality of display panel main bodies displays abnormally in remaining ones of the plurality of display panel main bodies.

17. A display panel comprising:
a display panel main body provided with a signal input end;
a testing portion provided with a test signal end, wherein the test portion comprises a testing circuit connected between the test signal end and the signal input end; and
a circuit board disposed on the testing portion, wherein the circuit board is electrically connected to the signal input end of the display panel main body.

18. The display panel according to claim 17, wherein the testing circuit comprises a signal line, an end of the signal line is connected to the test signal end, and another end of the signal line is connected to the main body of the display panel, so as to form a signal channel between the test signal end and the signal input end.

19. The display panel according to claim 18, wherein the testing circuit further comprises a control switch connected to the signal line, the test portion is further provided with a signal control end, the signal control end is electrically connected to the control switch, and the signal control end is configured for controlling the control switch to be on or off after receiving a control signal.

20. The display panel according to claim 18, wherein the display panel comprises a thin-film transistor layer, the thin-film transistor layer comprises a first thin-film transistor, and the first thin-film transistor is located in the display panel main body; the first thin-film transistor comprises a metal layer, and the signal line and the metal layer of the first thin-film transistor are disposed in a same layer.
